(19) United States
(12) Patent Application Publication
(10) Pub. No.: US 2007/0023135 A1
(43) Pub. Date: Feb. 1, 2007

(54) Method and device to produce a perforated web material

(76) Inventor: Claudio Giacometti, Pistoia (IT)

Correspondence Address: MCGLEW & TUTTLE, PC, P.O. BOX 9227, SCARBOROUGH STATION, SCARBOROUGH, NY, 10510-9227, US

(21) Appl. No.: 10/552,360

(22) PCT Filed: Apr. 2, 2003
(86) PCT No.: PCT/IT03/00198

§ 371 Date: Jun. 16, 2006

(51) Int. Cl. B32B 38/04; D04H 13/00; B26F 1/20; B28B 1/48

(52) U.S. Cl. 156/252; 156/62.6; 156/253; 156/510; 264/154; 425/290

(57) ABSTRACT

A method to produce a perforated web material, wherein the web material (N) is fed through a nip (11) between a first roller (7) and a second roller (9) rotating in opposite directions and pressed against each other, the first roller (7) being provided with protuberances (7P) for perforation. Characteristically, the web material is heated before being fed into said nip.

### TECHNICAL FIELD

The present invention relates to a method and a device for the perforation of a web material, for producing a semi-finished product destined, for example, to manufacture baby diapers, sanitary towels, incontinence pads, filters or similar products in which a permeable layer or web must be provided which allows a fluid to pass through a plurality of perforations.

### STATE OF THE ART

In the production of absorbent products for personal hygiene, such as sanitary towels, baby diapers, incontinence pads or similar, sheets or layers of perforated web material are employed to constitute the top layer of the product, destined to come into contact with the skin of the user. This layer is commonly known as “top-sheet”. In some cases the top-sheet is constituted by a perforated plastic film. In other cases it is formed of a perforated nonwoven fabric. It is also possible to employ for this function combined products constituted by several nonwoven fabrics, several films or also by layers of different types, such as films and nonwoven fabrics or films and webs of unconsolidated fibres, joined together with various techniques.

EP-A-0598970 describes a method and a system, to produce a perforated web material, in particular a film, but also a nonwoven fabric. According to this method, the web material is fed into a calender comprising two counter-rotating rollers defining, a nip through which the material to be perforated is fed. One, of the two rollers is provided with protuberances and the other is substantially smooth and if necessary may have an elastically yielding cylindrical surface, or may be made of a hard material, such as steel or the like, analogously to the roller equipped with the protuberances. The web material is perforated through the combined effect of the pressure between the two rollers, the temperature at which they are heated to and the difference in peripheral speed between the two rollers. The roller equipped with protuberances is faster than the smooth roller and this causes an effect of deformation and tearing of the web material at the protuberances.

DE-A-2614160 describes a different method of perforation, again employing a smooth roller and a roller provided with protuberances. This method is described with specific reference to the perforation of nonwoven fabrics.

Other devices and methods of perforating web materials, made of plastic film or nonwoven fabric, are described in U.S. Pat. No. 3,085,608, GB-B-484929, GB-A-1,270,777, EP-A-502273, U.S. Pat. No. 3,509,007; U.S. Pat. No. 3,292,619.

### OBJECTS AND SUMMARY OF THE INVENTION

Starting from the prior art discussed briefly above, the object of the present invention is to provide a particularly efficient method for producing a perforated web material destined to make absorbent items for personal hygiene or of another type, filters or in general to produce items that require the presence of a flexible perforated sheet.

Substantially, according to a first aspect the invention provides a method of producing a perforated web material, in which the web material is fed through a nip between a first roller and a second roller rotating in opposite directions and pressed against each other, the first roller being provided with protuberances for perforation, characterized in that the web material is heated before it travels through said nip.

As shall become more apparent from the detailed description hereunder, referring to some examples of embodiment, by preheating the web material prior to its entry into the nip defined between the perforator rollers it is possible to attain a series of advantages. Indeed, perforation of the web material in the nip between the two rollers requires a certain stay time between the rollers and the supply of a certain amount of energy. Perforation takes place through the combined action of pressure and heat supplied to the web material and (if there is a difference in peripheral speed between the two rollers) through the mechanical effect caused by this difference in speed. The higher the feed speed of the web material, the lower the stay time of the material in contact with the perforator rollers. This makes perforation critical. The need to obtain increasing production rates is limited by the need to keep the web material engaged between the perforator rollers for the time required to guarantee correct perforation over the entire width of the material and along its entire longitudinal extension.

By preheating the web material before it is fed to the nip between the perforator rollers it is possible to take the temperature of the material to a value that reduces the stay time required by the material in contact with the perforator rollers, allowing correct and accurate perforation of all the material while feeding the material at a high speed and thus reducing the time available to the perforator rollers to carry out perforation.

It is thus possible to increase the production rate and also to reduce energy consumption per unit of product.

The greater ease with which perforation of the material in the nip between the perforator rollers is obtained reduces mechanical stress on the material. Moreover, it is also possible to reduce or in some cases even eliminate the difference in peripheral speed between the first and the second roller. This allows further reduction in mechanical stress on the web material. In particular, when this is constituted by a nonwoven fabric or by a web of fibres the reduction in stress and mechanical stresses makes it possible to obtain a more regular product.

As the web material reaches the nip between the perforator rollers preheated, it is possible to reduce not only the operating temperature but also the pressure and percentage of slippage, that is the difference between the peripheral speeds. The reduction in pressure and of the difference in relative speed reduces the compression stresses and above all bending stresses to which the tips or protuberances provided on the first roller are subjected. Consequently, the protuberances may be produced of a greater height with consequent advantages with regard to the thickness of the finished product, in particular when this is constituted by a layer of textile fibres or comprises a layer of this type. The final thickness of the perforated material is an important factor for the subsequent applications of the semi-finished material. In fact, to produce sanitary towels, for example, it is important for the top sheet to be considerably thick, to isolate as much as possible the external surface of the absorbent product (which comes into contact with the skin of the user) from the layer underneath the top-sheet which absorbs body fluids. This characteristic of increased thickness of the web material is defined as “three-dimensionality” of the material.

The reduction in mechanical stress on the protuberances of the roller, which is obtained by the method of the present invention, also allows greater freedom of design and, as will be explained hereunder, thus increases the possibility of varying the layout, dimension and density of the perforations.

Although the method of the present invention is particularly advantageous for perforation of webs of textile fibres or nonwoven fabrics, or combined materials comprising at least a layer of textile fibres, some of the specific advantages summarized above and better described hereunder are also attained in the perforation of plastic films.

Although the web material is preheated before being fed into the nip between the rollers, this does not preclude at least one or both of the perforator rollers from being heated. Moreover, when necessary they may be made to rotate at different peripheral speeds, although it is generally possible to reduce this difference in speed to lower values than those used in prior art systems.

In general, the peripheral speeds of the two rollers defining the nip through which the web material is fed may be the same as or different from each other, also as a function of the characteristics of the web material to be perforated. Preferably, and in a per se known way, the speeds will differ from each other and in particular the peripheral speed of the roller provided with protuberances will be higher than the speed of the smooth roller.

In a particularly advantageous embodiment of the invention, the web material is a nonwoven fabric. In this case the nonwoven fabric may be produced already bonded with ode of the techniques known in the field and the nonwoven fabric may be fed to the production line of the perforated material for example by unwinding it from a roll. In a different embodiment, the nonwoven fabric is produced by a line that also performs perforation. For example, a station may be provided to form a web of unconsolidated (un-bonded) fibres, which is fed in succession to a heating station and to the calender composed of the two perforator rollers. In this way, together with heating and/or perforation, consolidation of the fibres by heating may also be performed in the heating station and/or the nip between the two rollers.

Therefore, in a preferred embodiment, the method comprises the following phases:
producing at least a web of unbonded fibres;
bonding said fibres to form a nonwoven fabric;
feeding the preheated nonwoven fabric into said nip.

In particular the following phases may be provided:
producing at least a web of unbonded fibres;
feeding the web of unbonded fibres through at least a heating and bonding station to bond said fibres and form a nonwoven fabric;
feeding the preheated nonwoven fabric delivered from the heating and bonding station into the nip of the calender to perforate the previously bonded material.

Heating and bonding may be performed by an air-through system. This technique to consolidate or bond the webs of fibres is known to those skilled in the art and consists in making hot air flow through the web of fibres. The temperature of the air is sufficiently high to cause partial melting and/or plasticization of the fibres which bond with one another. Normally and advantageously the web of fibres is constituted totally or in part by so-called bicomponent fibres, that is with a core formed by a polymer with higher plasticization and melting temperatures compared to the polymer forming the external sheath enclosing the core. However, the fibres may also be consolidated with other techniques known in the field of nonwoven fabrics, for example by applying a bonding agent which may also be a heat-activated bonding agent, that is causing adhesion when the web is heated. It is also possible to perform bonding by mechanical needle-punching, preferably on the cold web, and therefore before it is fed to the heating station.

In a different embodiment, the method may comprise the following steps:
producing at least a web of unbonded fibres;
feeding the web of unbonded fibres to a heating station and preheating the web;
feeding the preheated web of fibre into the nip between the first and the second roller;
bonding the fibres to form the nonwoven fabric and perforating the web of fibres in the nip between the perforator rollers through the effect of the heat and pressure between the rollers.

Intermediate solutions, in which bonding of the web of fibres occurs partly in the heating station and partly in the nip of the calender, that is between the two rollers, are also possible.

The web material may be constituted, rather than by a single web of fibres, also by several web of fibres produced in series or also combined and consolidated in a production phase different from the perforation phase. In the first case two or more webs produced by two or more machines, such as carding machines or similar, may be fed along respective feed paths and combined before perforation. The several webs may for example be superimposed before entering a single heating station in which preheating and joining together of the webs and bonding of the fibres is performed. Alternatively, the webs may simply be preheated in the heating station and joined together and bonded in the nip between the rollers. Then again, intermediate solutions may be used, in which part of the reciprocal joining of the webs and/or consolidation (bonding) of the fibres of each web takes place partly in the heating station and partly in the nip between the rollers. According to a different embodiment, the individual webs may be individually bonded and preheated in respective heating and bonding stations and then joined together by lamination in the nip between the rollers.

The web material may also be constituted by a composite structure comprising for example a layer of nonwoven fabric or a web of unconsolidated fibres and a plastic film. Also in this case combining and reciprocal bonding of the layer of fibres and the plastic film may take place in the heating station, in the nip between the rollers or also in a separate and additional station, for example upstream of the heating station.

According to a different aspect, the invention relates to a production line to produce a perforated web material, comprising at least a path to feed a web material to a perforation station comprising a first roller and a second roller rotating in opposite directions and pressed against each other, defining a nip through which the web material is fed, the first roller being provided with protuberances for perforation. Characteristically, according to the invention, a heating station is provided upstream of said perforation station, through which said feed path passes and in which the web material is preheated before being fed to said perforation station.

Further advantageous features and embodiments of the method and of the production line according to the invention are indicated in the attached dependent claims and shall be described in greater detail with reference to some examples of embodiment.

### BRIEF DESCRIPTION OF THE DRAWINGS

The invention shall now be better understood with reference to the detailed description hereunder of some non-limiting examples of embodiments, with reference to the attached drawings. The drawings, in which identical or equivalent parts are indicated with the same reference numbers, show:

FIG. 1 a diagram of a production line according to the invention in a first embodiment;

FIG. 2 a schematic enlarged local section of the perforated web material;

FIG. 3 a diagram of a production line according to the invention in a second embodiment;

FIG. 4 a diagram to show the advantages of the invention;

FIG. 5 a greatly enlarged local section of a portion of the cylindrical surface of the first roller;

FIGS. 6 to 9 diagrams of further embodiments of the production line according to the invention.

### DETAILED DESCRIPTION OF THE PREFERRED EMBODIMENTS OF THE INVENTION

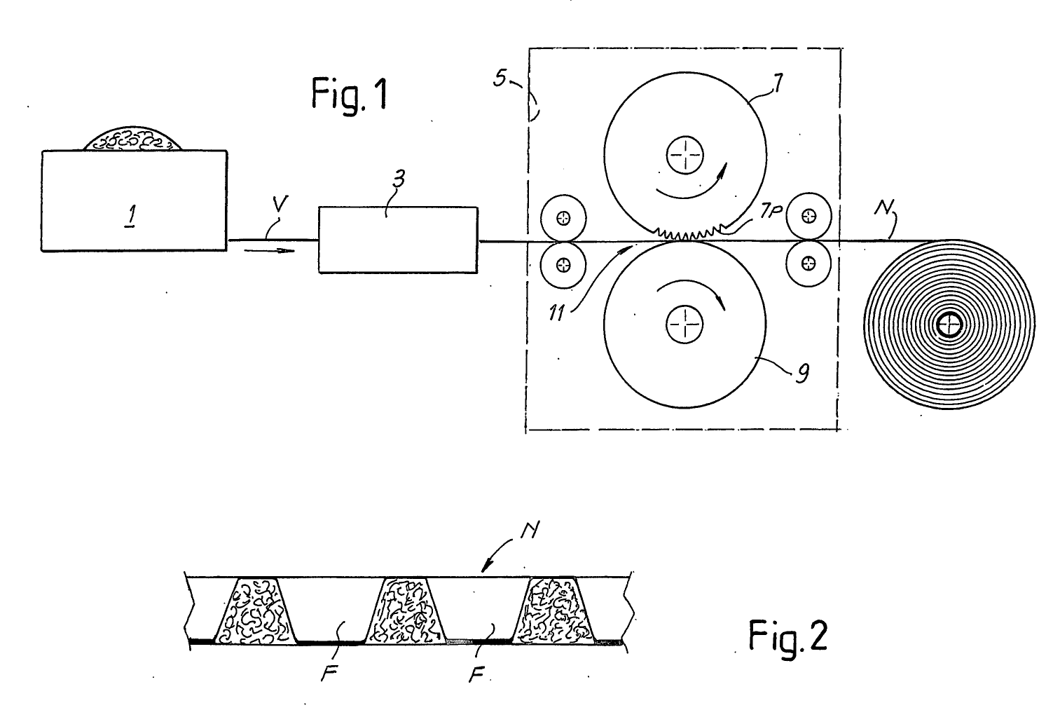

With initial reference to FIG. 1, in a first embodiment the production line comprises a machine 1 to produce a web material N. The material is advantageously a nonwoven fabric obtained starting from a web of unconsolidated fibres produced by the machine 1. This may be a carding machine, a rando-webber or another machine suitable to produce a web of fibres. Therefore, in the first part of the production line the web material is constituted by a web of unconsolidated fibres. A heating station 3, which may be constituted by a consolidation station using air-through technology, is positioned along the path of this web material. In these known devices, which are not described in greater detail herein, a current of hot air is blown through the web of fibres to be consolidated to cause plasticization or partial melting of the fibres or of some of the fibres to consolidate the web. Therefore, upon delivery from the station 3, the web material N is a nonwoven fabric which has a higher temperature compared to the ambient temperature. Typically, the temperature of the web material N may be around 40-80° C. and preferably around 60° C., although this must not be intended as a binding value.

The web material N preheated in this way is fed to a calender 5 comprising a first roller 7 and a second roller 9. The rollers 7 and 9 are counter-rotating around respective axes parallel with each other and define a nip 11 through which the web material is fed. Means to feed and draw the web material, represented schematically by pairs of rollers, to impart the required speed to the web material, may be positioned upstream and/or downstream of the rollers 7 and 9.

The top roller 7 is equipped with a plurality of protuberances or tips 7P, visible in particular in the enlarged section in FIG. 7. The section of the protuberances may be square, circular, elliptical, rectangular or of any other suitable shape, as a function of the shape required for the holes to be produced in the web material N. The second roller 9, on the other hand, has a smooth surface and may be provided with an elastically yielding surface. Through the effect of the pressure between the rollers and by further supply of heat through one or both of the rollers 7, 9 the web material is perforated as shown in the schematic and enlarged detail in FIG. 2, where the holes are indicated with F. Perforation may also be performed with the aid of reciprocal slippage of the protuberances 7P of the roller 7 in relation to the surface of the roller 9, providing a difference in peripheral speed between the two rollers.

Thanks to the fact that the web material N reaches the nip 11 preheated, a plurality of advantages are obtained. In the first place, the quantity of heat to be supplied to the web material by the rollers 7, 9 to reach the temperature required for perforation is lower. Therefore, the temperature of the rollers may be kept lower and/or the time for which the web material N remains in contact with the rollers may be reduced. This means that the production rate may be higher than the production rate obtainable with traditional systems in which the web material comes into contact with the rollers when it is still at ambient temperature. Alternatively, the time for which the web material remains in contact with the rollers 7, 9 may be kept substantially the same as traditional systems, obtaining more reliable perforation.

These advantages can be easily understood by comparing the diagrams (A), (B) and (C) in FIG. 4. The diagram in FIG. 4(A) shows the overall time Δt during which the web material N is in contact with at least one of the two rollers 7, 9. The lower the feed speed of the web material the higher this time is. In traditional systems, such as the one described in EP-A-0598970, the time Δt is required to perform: heating of the web material, at least partial melting of it in the areas in which it is to be perforated and tearing to form the perforation, through the difference in peripheral speed between the two rollers. The times required for these three operations are indicated in FIG. 4A with Δt_{R}, Δt_{F} and Δtₛ respectively. The procedure must be reliable, that is correct perforation of the web material must be guaranteed in the finished product in the entire area subject to perforation. Areas in which perforation is incomplete are not admissible. Since the rollers 7 and 9 become deformed by their own weight forming a camber, situations may occur in which the web material is correctly perforated in the centre and incorrectly perforated in the areas nearer the edge. To prevent this drawback, which would make the web material unacceptable for the subsequent processes, it is necessary to increase the temperature of the rollers and/or to increase the pressure with which they are pressed against each other and/or to increase reciprocal slippage of the rollers, that is the difference in peripheral speed and/or to increase the time for which the web material remains in contact with the rollers, that is the production rate must be slowed.

Notwithstanding the method adopted, this has a negative effect on the cost of the process, both due to an increase in energy consumption (deriving from the increase in thermal energy required, but also from the increase in electric power absorbed to run the motors that operate the rollers if they are subject to increased pressure or to increased reciprocal slippage), and due to an increase in wear on the rollers caused by pressure and slippage.

Preheating of the web material eliminates these drawbacks increasing the reliability of the procedure without having a high incidence on power consumption or on wear. Indeed, as can be seen in FIG. 4(B), if the web material reaches the nip 11 preheated, the entire time Δt during which the web material remains in contact with the rollers 7, 9 is utilized to melt the material (time Δt_{F}, normally lower than the time required in traditional processes) and to perform tearing. The time Δtₛ available to perform tearing and thus perforation is much higher and this is therefore guaranteed without the need to increase temperature, pressure and/or slippage between the rollers.

Thanks to preheating it is also possible to increase the production rate and thus to reduce the total time during which each single section of the web material N remains in contact with the rollers 7, 9. This is shown in FIG. 4(C), where the interval of total contact time is indicated with Δt1. The time available for tearing is in any case greater than the time in the situation in FIG. 4(A).

Summarising, preheating allows more time to obtain perforation of the material. This increased time available ensures that perforation is obtained even in the most critical areas of the web material, typically along the edges.

The power consumption required to preheat the web material is compensated by the increased productivity of the system and by the reduction in thermal energy to be supplied to the rollers 7, 9. The total energy balance shows a reduction in energy per unit of product delivered from the system.

The advantages of preheating, moreover, are not limited to those described hereinbefore. In fact, by reducing the reciprocal pressure between the rollers and the difference in speed between the rollers 7, 9 there is a drastic reduction in the compression and, above all, the bending stresses on the protuberances 7P. These protuberances (see FIG. 5) are proportioned taking into account the bending stresses deriving from friction between the two rollers, which increase in relation to increase in pressure and difference in peripheral speed. In traditional rollers the extremely high bending stress deriving from the high pressures between the two rollers and the considerable difference in relative speed makes it necessary for each protuberance 7P to have a large resistant cross section, that is a high value of the dimension D1, which may be a diagonal in the case of rectangular or square section, or a diameter in the case of circular section. The transverse dimension D2 of the end of each protuberance is also dictated by the trend of the cross section along the height H of the protuberance. This causes considerable restrictions both on the dimension of the hole (which depends on D2) and on the density of the holes, that is their reciprocal distance, which depends on D1. Having reduced the total bending stress on each protuberance, greater freedom of design is obtained, as the minimum limits of D1 and D2 are less restricting. This makes it possible to obtain dimensions of the holes and densities of the holes that were previously unobtainable. It is also possible to adopt forms of the cross section of the protuberances (and therefore of the holes) which are not compatible with the bending stress requirements to be complied with in traditional lines.

Lower bending stress also makes it possible to produce protuberances of increased height H. Not only does this allow greater freedom in choosing the dimensions D1 and D2, but also reduction in the compression of the web material between the protuberances. Therefore, the web material delivered maintains a greater volume and in particular a greater thickness. Typically, the height H of the tips may be between 0.2 and 3 mm and advantageously between 0.5 and 1.2 mm.

In some cases the web material N must only be perforated in strips, that is it must have perforated strips and integral strips. This material is employed particularly for the subsequent production of sanitary towels. EP-A-0598970 describes and illustrates a perforator roller to perform this particular type of processing. In general the roller 7 may have annular areas with protuberances of a reduced height corresponding to the strips of web material to remain integral, alternated by areas equipped with protuberances 7P of an increased height. The protuberances of a reduced height are provided to perform consolidation of the fibres but must not break through the material.

According to the traditional method, this type of processing is particularly critical as a point of balance must be found between the need to avoid perforating the web material and the need to consolidate the fibres along the entire extension of the material. This makes it necessary to machine the roller 7 with extreme precision to obtain extremely accurate differences in the height of the protuberances. If the protuberances of reduced height are too short in relation to the protuberances of increased height this may cause insufficient or total absence of consolidation or bonding of the fibres in the unperforated areas of the web material. On the other hand, if the difference in height is too slight the web material may also be perforted in the strip which should remain integral.

The process according to the invention also solves this problem in particular when bonding of the fibres is performed together with preheating in the station 3. In this case only perforation is to be performed in the nip between the rollers 7 and 9 and therefore the annular areas of the roller 7 where the web material must not be perforated may even be smooth, that is without protuberances, which avoids the risk of accidental perforation.

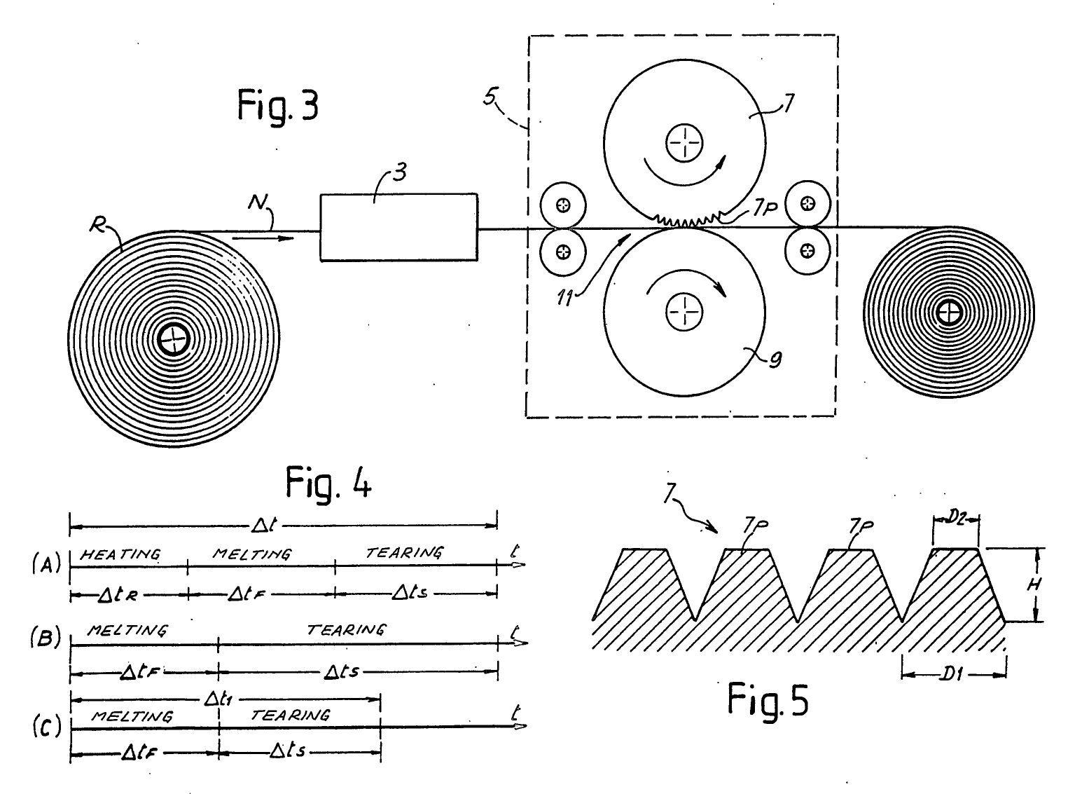

The advantages described hereinbefore (with the exception of those relative to problems strictly linked to the use of textile materials in fibre) can also be obtained when the production line is fed directly with a web material constituted by a nonwoven fabric or a film. FIG. 3, where parts identical or equivalent to those in FIG. 1 are indicated with the same numbers, shows a diagram of a system of this type, where the web material N is fed from a roll R (of plastic film or nonwoven fabric) directly to the heating station. In this case, bonding of the fibres is not required and it may be constituted simply by an oven, for example with infrared rays. Also in the example in FIG. 1, it would be possible for the station 3 only to heat the web material, with consolidation performed directly in the nip 11 between the two rollers 7, 9 thanks to the effect of the protuberances 7P.

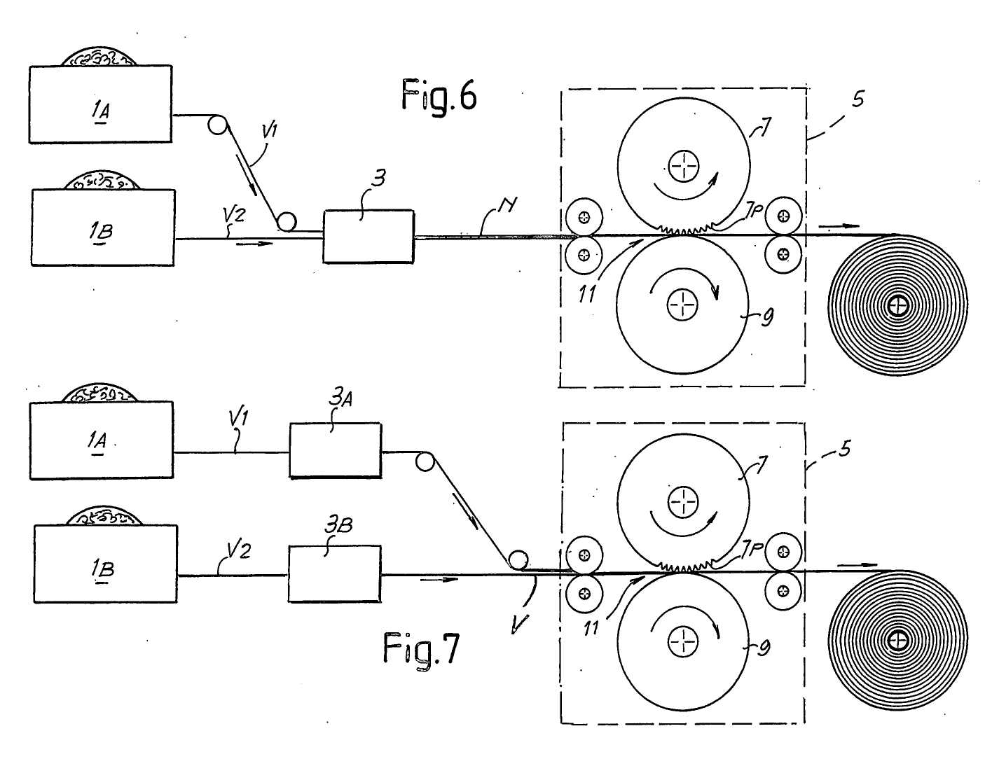

FIG. 6 shows a system in which the web material is formed by superimposing two webs V1 and V2 of unconsolidated fibres, fed from two machines 1A, 1B. The two webs V1 and V2 are superimposed before entering the heating station 3, where they are joined together simultaneously to bonding of the fibres.

FIG. 7 shows a different embodiment in relation to FIG. 6, in which the two webs V1 and V2 are heated, and if necessary bonded, in two separate heating stations 3A and 3B. The two preheated and if necessary bonded webs are then fed to the nip 11 of the calender 5, between the rollers 7 and 9 which perform perforation and reciprocal joining of the two layers formed from the two webs V1 and V2.

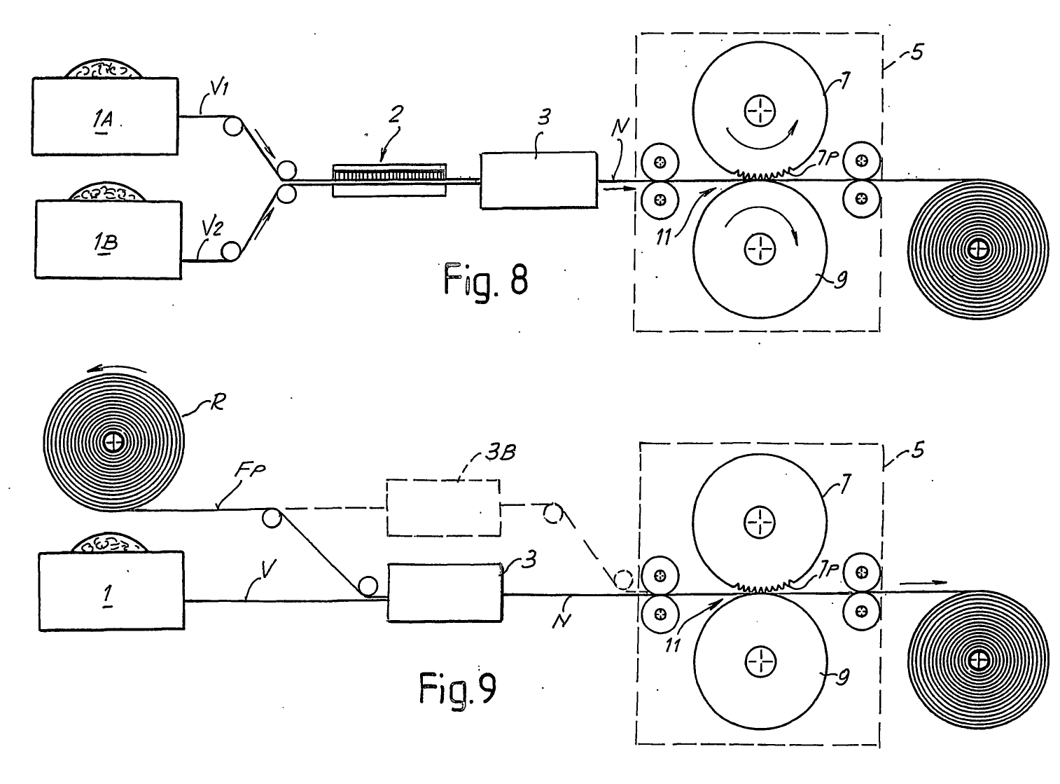

FIG. 8 shows a different embodiment in relation to FIG. 6, in which the two webs V1 and V2 are joined together, and if necessary bonded, in a station 2 upstream of the heating station. The station 2 may for example be a mechanical needle-punching station, or even a heating station.

FIG. 9 shows a different embodiment in which the web material is constituted by combining a plastic film FP fed from a roll R and a fiber web V fed from a machine 1. The two layers FP and V are combined before entering the heating station 3 and here preheated and if necessary joined together by partial melting of the fibres. Joining together may also be performed, both in this case and in the others described above, for example with an ultrasound heating system, with appropriately positioned melting points.

FIG. 9 also shows with a dashed line a variant in which the plastic film FP is heated in a separate heating station 3B and combined with the web V, preheated and if necessary consolidated in the station 3, immediately before being fed into the nip 11.

By preheating the web material it is possible to use values of the feed speed of the web material and values of the roller speeds which cause less stress on the material, a particularly important factor when the web material is a nonwoven fabric. Typically, by indicating with
Va the feed speed of the web material at the entrance to the nip 11
V7 the peripheral speed of the roller 7
V9 the peripheral speed of the roller 9
Vu the delivery speed of the web material from the nip 11 the following value ratios may be adopted:
Va may be equal to, less than or higher than Vu
V9 may be equal to or less than Va
Va may be between 90 and 100% of V7, and between 90 and 110% of V9;
V9 may be between 80% and 100% of V7.

The linear pressure, that is the load per unit of length, between the two rollers 7 and 9 may be between 40 and 220 kg/cm and the temperature of the rollers may be between 20 and 250%, according to the type of material treated.

It is understood that the drawings merely show possible examples of non-limiting embodiments of the invention, the forms and layouts of which may vary without departing from the scope of the concept on which the invention is based. Any reference numbers in the attached claims are provided to facilitate reading of the claims with reference to the description and do not limit the scope of protection represented by the claims whatsoever.

In the claims:

1. A method to produce a perforated web material, wherein the web material is fed through a nip between a first roller and a second roller rotating in opposite directions and pressed against each other, the first roller being provided with protuberances for perforation, characterized in that the web material is preheated before being fed into said nip, and the web is fed into the nip in a preheated condition at a temperature higher than the ambient temperature.

2. Method as claimed in claim 1, characterized in that at least one of said first and second roller is heated.

3. Method as claimed in claim 1, characterized in that said first and said second roller rotate with a different peripheral speed to each other.

4. Method as claimed in claim 3, characterized in that said first roller rotates at a higher peripheral speed than said second roller.

5. Method as claimed in claim 1, characterized in that said web material is a nonwoven fabric.

6. Method as claimed in claim 5, characterized by:
producing at least a web of fibres;
bonding said fibres to form a nonwoven fabric;
feeding the preheated nonwoven fabric into said nip.

7. Method as claimed in claim 6, characterized in that said web is produced and bonded in series upstream of said nip.

8. Method as claimed in claim 6, characterized by the phases of:
producing at least a web of unbonded fibres:
feeding said web of unbonded fibres through at least a heating and bonding station to bond said fibres and form a nonwoven fabric;
feeding the nonwoven fabric preheated in said at least a heating and bonding station into said nip.

9. Method as claimed in claim 8, characterized in that heating and bonding are performed using an air-through system.

10. Method as claimed in claim 6, characterized in that the nonwoven fabric is fed into said nip with an input speed equal to or lower than the peripheral speed of the first roller.

11. Method as claimed in claim 12, characterized in that said second roller is rotated at a peripheral speed lower than or equal to the peripheral speed of said first roller.

12. Method as claimed in claim 10, characterized in that the feed speed of the nonwoven fabric into said nip is between 90% and 100% of the peripheral speed of the first roller.

13. Method as claimed in claim 12, characterized in that the feed speed of the nonwoven fabric into said nip is between 90% and 110% of the peripheral speed of the second roller.

14. Method as claimed in claim 12, characterized in that the peripheral speed of the second roller is between 50% and 100% of the peripheral speed of the first roller.

15. Method as claimed in claim 5, characterized by the phases of:
producing at least a web of unbonded fibres;
feeding said web of unbonded fibres to a heating station:
feeding the web of fibres preheated in said heating station into said nip;
bonding the fibres to form the nonwoven fabric and perforating the web of fibres in said nip.

16. Method as claimed in claim 15, characterized in that the web of unbonded fibres is fed into said nip with an input speed lower than the peripheral speed of the first roller, said peripheral speed of the first roller being equal to or higher than the peripheral speed of the second roller.

17. Method as claimed in claim 16, characterized in that a delivery speed equal to or higher than the peripheral speed of the first roller is imparted to the web material delivered from said nip.

18. Method as claimed in claim 16, characterized in that the feed speed of the web of fibres into said nip is between 50% and 90% of the peripheral speed of the first roller.

19. Method as claimed in claim 5, characterized in that two or more web of fibres are coupled and joined together.

20. Method as claimed in claim 19, characterized by: forming at least a first and a second web of unbonded fibres; joining said first and said second web together and consolidating said fibres in said heating station.

21. Method as claimed in claim 19, characterized by:
forming at least a first and a second web of unbonded fibres; feeding said first and second web of unbonded fibres to one or two heating and bonding stations for preheating and separately bonding the fibres of the first and of the second web to form two nonwoven fabrics;
feeding said two preheated nonwoven fabrics into said nip;
perforating and joining together said two nonwoven fabrics in said nip.

22. Method as claimed in claim 5, characterized in that said web material comprises bicomponent fibres.

23. Method as claimed in claim 5, characterized in that a plastic film is combined with said nonwoven fabric or with said web of unconsolidated fibres.

24. Method as claimed in claim 1, characterized in that said web material comprises at least a plastic film.

25. A production line to produce a perforated web material, comprising at least a path to feed a web material to a perforation station comprising a first roller and a second roller rotating in opposite directions and pressed against each other, defining a nip through which the web material is fed; the first roller being provided with protuberances for perforation; characterized in that a heating station is provided upstream of said perforation station, through which said feed path passes and in which the web material is preheated before being fed to said perforation station, said heating station and said perforation station being arranged such that the web enters said perforation station in a preheated condition at a temperature higher than the ambient temperature.

26. Production line as claimed in claim 25, characterized in that at least one of the rollers of the perforation station is heated.

27. Production line as claimed in claim 25, characterized in that the two rollers of the perforation station are controlled so that they rotate at different peripheral speeds from each other.

28. Production line as claimed in claim 27, characterized in that said first roller rotates at a peripheral speed higher than the peripheral speed of said second roller.

29. Production line as claimed in claim 25, characterized in that bonding devices are provided along said feed path to bond the fibres of a web of unbonded fibres and form a nonwoven fabric, which is fed to said perforation station.

30. Production line as claimed in claim 29, characterized in that said bonding devices comprise a bonding system of the air-through type.

31. Production line as claimed in claim 25, characterized in that it comprises at least a machine to produce a web of fibres.

32. Production line as claimed in claim 25, characterized in that it comprises joining devices to join together two or more layers destined to form said web material.

33. Production line as claimed in claim 32, characterized in that said joining devices comprise means to consolidate two webs of fibres to each other.

34. Production line as claimed in claim 25, characterized in that it comprises two feed paths for at least two components destined to form said web material, said two feed paths uniting before passing through said perforation station.
